(19) United States
(12) Patent Application Publication
(10) Pub. No.: US 2008/0308964 A1
(43) Pub. Date: Dec. 18, 2008

(54) Method for forming film of silane coupling agent

(75) Inventors: Tsuyoshi Amatani, Amagasaki-shi (JP); Mutsuyuki Kawaguchi, Amagasaki-shi (JP); Satoshi Saitou, Amagasaki-shi (JP); Masashi Deguchi, Amagasaki-shi (JP)

Correspondence Address: BIRCH STEWART KOLASCH & BIRCH, PO BOX 747, FALLS CHURCH, VA, 22040-0747, US

(73) Assignee: MEC COMPANY LTD.

(21) Appl. No.: 12/213,053

(22) Filed: Jun. 13, 2008

(30) Foreign Application Priority Data
Jun. 15, 2007 (JP) 2007-159173

(51) Int. Cl. B28B 11/04

(52) U.S. Cl. 264/131

(57) ABSTRACT

A method for forming a film of silane coupling agent on a metal surface is provided. The method includes: a step of applying a solution containing a silane coupling agent on the metal surface; a step of drying the metal surface coated with the solution at a temperature in the range of 25 to 150° C. and for a length of time of 5 minutes or less; and a step of water-rinsing the dried metal surface.

### BACKGROUND OF THE INVENTION

The present invention relates to a method for forming a film of silane coupling agent on a metal surface.

In the manufacture of printed wiring boards, it has been the common practice to form the film of silane coupling agent on the metal surface for the purpose of enhancing adhesion between a surface of a conductor formed of a metal such as copper or a copper alloy and an insulating resin such as a solder resist or prepreg. The film of silane coupling agent is formed on the metal surface by the steps of dissolving the silane coupling agent in water or an organic solvent, applying the resultant solution to the metal surface and drying the solution.

In Japanese Unexamined Patent Publication No. 304361/1993, for example, the following processes are disclosed as the prior-art techniques which include: (1) a process wherein after a coupling agent treatment (applying a solution containing the silane coupling agent to the metal surface), the solution coating is subjected to 1-hour air drying followed by 3-hours drying at 80° C.; (2) a process wherein after the coupling agent treatment, the solution coating is allowed to stand for 24 hours and subjected to 3-hours drying at 80° C.; (3) a process wherein after the coupling agent treatment, the solution coating is allowed to stand for 24 hours and subjected to 3-hours drying at 100° C.; and (4) a process wherein after the coupling agent treatment, the solution coating is allowed to stand for 24 hours and subjected to 1-hour drying at 120° C. Another process is disclosed in Paragraph [0012] of Japanese Unexamined Patent Publication No. 37452/1994. This process includes the steps of dipping a metal material in the silane coupling agent and drying the resultant coating, not water-rinsed, at a temperature in the range of 120 to 140° C. for 30 minutes. Yet another process is disclosed in Paragraph [0024] of Japanese Unexamined Patent Publication No. 212039/1995. In this process, the silane coupling treatment is followed by baking the solution coating at a temperature of 155° C. or more (for 5 to 180 minutes).

The following problem may be encountered in the process wherein after the application of the silane coupling agent by dip coating or spray coating, the solution coating is simply dried at 100° C. to 120° C. for 30 to 60 minutes as commonly practiced in the art to create bond between the silane coupling agent and the metal surface. The drying step causes excessively adhered silane coupling agent to interlock with the metal surface so that the coating solution may be unevenly adhered to the metal surface. Such an uneven adherence of the coating solution may sometimes affect the subsequent step.

In a case where a copper material is subjected to Ni—Au plating, for example, the following problem may arise. The copper material must be removed of the silane coupling agent and a surface treatment (e.g., tin plating or an adhesion enhancing layer) on its surface before it is subjected to Ni—Au plating. However, the above substances cannot be removed properly because of the silane coupling agent unevenly adhered to the copper surface.

The following measure is adopted to prevent the occurrence of such coating unevenness and to form a uniform film of silane coupling agent. The measure is (1) to perform a water-rinsing step between the dip coating step and the drying step thereby rinsing off an excess of silane coupling agent or (2) to apply the solution by a spin coat method. Disclosed in Paragraph [0053] of Japanese Unexamined Patent Publication No. 2007-35995, for example, is a process which includes the steps of dipping a metal material in the silane coupling agent for 1 minute, rinsing the resultant coating with water and drying the coating at 100° C. for 30 minutes. Further, the process including the steps of dipping a metal material in a silane coupling agent for 1 minute, rinsing the resultant coating with water and drying the coating at 100° C. for 30 minutes is disclosed in Paragraph [0013] of Japanese Unexamined Patent Publication No. 115275/1995.

However, in the case (1) where the water-rinsing step is performed between the dip coating step and the drying step, the coating solution thus applied is water-rinsed before the silane coupling agent forms covalent bond with the metal surface. Hence, some of the required amount of silane coupling agent is rinsed off so that the amount of silane on the metal surface is reduced. In the case (2) where the solution is applied by the spin coat method, the conveyance of substrates by means of a series of conveyor processes conventionally used in the manufacture of printed wiring boards is impracticable. Further, there is restriction on the area of the substrate because high speed rotation of the substrate is required.

### SUMMARY OF THE INVENTION

The invention is directed to the solution to the above-described problems in the prior art. The invention seeks to provide a method for forming a uniform film of silane coupling agent which is free from the coating unevenness and retains a sufficient amount of surface silane.

A method for forming a film of silane coupling agent (hereinafter, simply referred to as “forming method”) according to the invention is a method for forming the film of silane coupling agent on a metal surface which includes: a step of applying a solution containing a silane coupling agent on the metal surface; a step of drying the metal surface coated with the solution at a temperature in the range of 25 to 150° C. and for a length of time of 5 minutes or less; and a step of water-rinsing the dried metal surface.

The invention features a brief drying step based on conditions including the temperature range of 25 to 150° C. and the drying time of 5 minutes or less, under which conditions an excess of silane coupling agent is not allowed to interlock with the metal surface. In this drying step, only the silane coupling agent present in proximity to the metal surface is made to bind to the metal surface. In the subsequent water-rinsing step, the excessive silane coupling agent, which has not yet interlocked with the metal surface, is rinsed off. Thus, the invention makes it possible to form, on the metal surface, the uniform film of silane coupling agent which is free from the coating unevenness and retains a sufficient amount of surface silane.

### BRIEF DESCRIPTION OF THE DRAWINGS

FIGS. 1(a) to 1(d) are sectional views for illustrating the steps of a forming method according to one embodiment of the invention; and

FIGS. 2(a) to 2(c) are sectional views for illustrating the steps of a conventional forming method.

### DETAILED DESCRIPTION

According to a forming method of the invention, a coating step of applying a silane coupling agent to a metal surface by dip coating, spray coating or the like is followed by a brief drying step which is performed at such a temperature and for such a length of time as not to allow an excess of silane coupling agent to interlock with the metal surface. Thereafter, a water-rinsing step is performed. The brief drying step based on the conditions to prevent the excessive silane coupling agent from interlocking with the metal surface is interposed between the coating step and the water-rinsing step whereby only the silane coupling agent present in proximity to the metal surface is allowed to bind to the metal surface. In the subsequent water-rinsing step, the excessive silane coupling agent, which has not yet interlocked with the metal surface, is rinsed off. Thus, the invention makes it possible to form, on the metal surface, a uniform film of silane coupling agent which is free from coating unevenness and retains a sufficient amount of surface silane.

Specifically, after the coating step of applying the silane coupling agent to the metal surface (by dip coating, spray coating or the like), the brief drying step is performed at a temperature in the range of 25° C. to 150° C., at which the excessive silane coupling agent is not allowed to interlock with the metal surface, and for a length of time of 5 seconds to 5 minutes or preferably of 30 to 150 seconds. In the subsequent water-rinsing step, the excessive silane coupling agent, which has not yet interlocked with the metal surface, is rinsed off so that it is possible to form the uniform film of silane coupling agent which is free from the coating unevenness and retains a sufficient amount of surface silane.

Particularly, in the manufacture of printed wiring boards, the following problem may be encountered when the film of silane coupling agent is formed on the metal surface for the purpose of enhancing adhesion between a surface of a conductor formed of a metal such as copper or a copper alloy and an insulating resin such as a solder resist or prepreg. If the silane coupling film has thickness unevenness, the adhesion between the conductor surface and the resin decreases. However, the invention is suitable for solving this problem.

A usable silane coupling agent according to the forming method of the invention is not particularly limited and any silane coupling agent having an epoxy group may be used arbitrarily. In a case where one or more than one of the silane coupling agents having the epoxy group, such as 3-glycidoxypropyltrimethoxysilane, 3-glycidoxypropyltriethoxysilane, 2-(3,4-epoxycyclohexyl)ethyltrimethoxysilane and 3-glycidoxypropylmethyldiethoxysilane are used, there may be obtained an advantage that the uneven adherence of the coating solution is less likely to occur.

While the usage of the silane coupling agent is not particularly limited, the silane coupling agent is commonly used as an aqueous solution. The concentrations of the silane coupling agent may preferably be in the range of 0.3 to 15 wt % or more preferably of 0.5 to 10 wt %. If the concentrations of the silane coupling agent are in the above range, the silane coupling agent exhibits a good solubility so that silane can be made to adhere to the metal surface in a required amount for enhancing the adhesion to the resin.

According to the forming method of the invention, the coating method for applying the silane coupling agent to the metal surface is not particularly limited and any of the normally used coating methods such as spray coating and dip coating may be used as needed.

According to the invention, the drying step following the application of the silane coupling agent must be performed at a temperature as low as and in a time as short as to allow just a required amount of silane coupling agent present in proximity to the metal surface to interlock with the metal surface.

The drying temperature and the drying time may be changed arbitrarily according to the type of the silane coupling agent, the type of a base metal and the like. For example, drying temperature in the range of 25° C. to 150° C. and drying time in the range of 5 seconds to 5 minutes are preferable, and drying temperature in the range of 70° C. to 120° C. and drying time in the range of 30 seconds to 150 seconds are particularly preferable. If the drying temperature is lower than the above range, a required amount of silane coupling agent cannot be made to adhere to the metal surface. On the other hand, if the drying temperature is higher than the above range, the film formation proceeds in a state where the silane coupling agent is unevenly adhered to the metal surface and hence, the resultant silane coupling film has thickness unevenness. The silane coupling film having the thickness unevenness is also formed if the drying time is longer than 5 minutes. On the other hand, if the drying time is shorter than 5 seconds, the applied silane coupling agent is not fully dried, which leads to inability to form a silane coupling film retaining a sufficient amount of surface silane.

A water-rinsing condition according to the invention is not particularly limited. Even 300-second rinsing in flowing water, for example, can rinse off an excess of uninterlocked silane coupling agent as maintaining the required amount of silane coupling agent in adhesion. This is thought to be the result of the preceding quick, low-temperature drying step which can make the required amount of silane coupling agent bind to the metal surface.

While the base metal coated with the film of silane coupling agent may be any metal such as tin, aluminum, titanium and alloys thereof, copper or a copper alloy widely used as a conductor is particularly preferred.

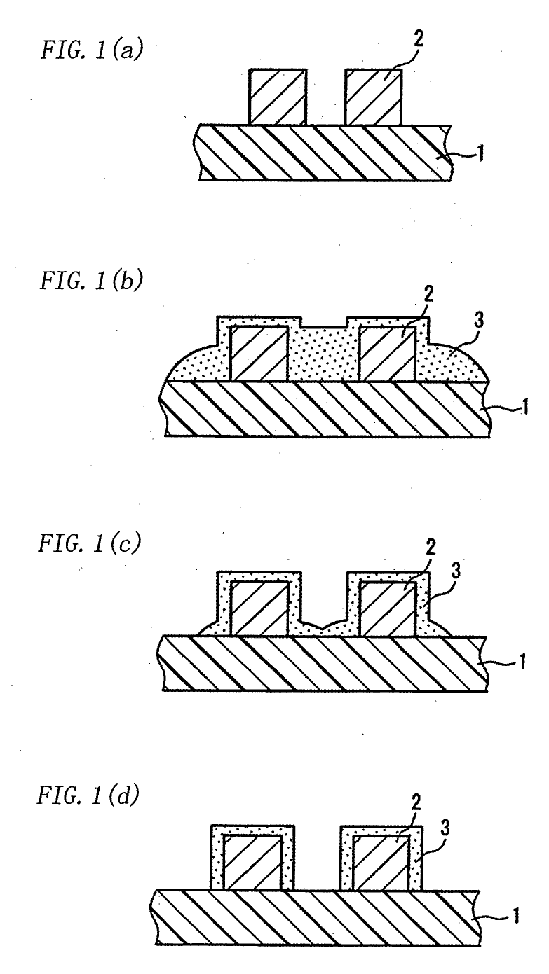

Next, the forming method of the invention is described with reference to the drawings. FIG. 1(a) to FIG. 1(d) are a group of sectional views for illustrating the steps of a forming method according to one embodiment of the invention. First, a metal piece 2 is laid on a surface of a resin substrate 1, as shown in FIG. 1(a). Subsequently, a solution containing the silane coupling agent is applied to a surface of the metal piece 2 (FIG. 1(b)). Next, the metal piece 2 coated with the solution containing the silane coupling agent is dried at a temperature of 25 to 150° C. for 5 minutes or less (FIG. 1(c)). Subsequently, the coating is rinsed with water whereby a uniform film of silane coupling agent 3 can be obtained which allows only the silane coupling agent present in proximity to the metal surface to bind to the metal surface and which is free from the coating unevenness and retains a sufficient amount of surface silane as shown in FIG. 1(d).

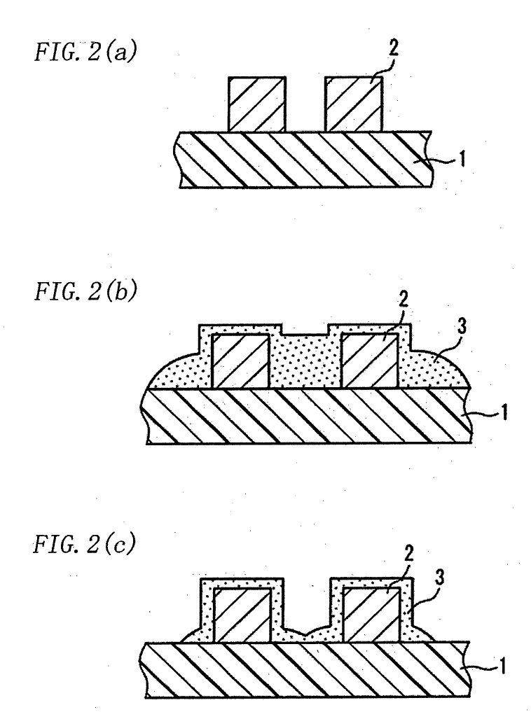

FIG. 2(a) to FIG. 2(c) are sectional views for illustrating the steps of a conventional forming method. First, the metal piece 2 is laid on the surface of the resin substrate 1, as shown in FIG. 2(a). Subsequently, the solution containing the silane coupling agent 3 is applied to the surface of the metal piece 2 (FIG. 2(b)). Next, the metal piece 2 coated with the solution containing the silane coupling agent is dried at a temperature of 120° C. for 30 minutes (FIG. 2(c)). This method has a problem that the film of silane coupling agent 3 is excessively adhered to the metal piece 2 in uneven thicknesses.

While the examples of the forming method of the invention will be described as below, it is to be noted that the invention is not limited to the following examples.

### EXAMPLE 1

An electrodeposited copper foil for use in printed wiring board having a thickness of 35 μm (commercially available from MITSUI MINING&SMELTING CO., LTD under the trade name of 3EC-III) was cut into a 10 cm-square piece, which was subjected to dip plating as surface treatment for forming an adhesive metal layer thereon.

An aqueous solution containing acetic acid, stannous acetate, silver acetate, thiourea, diethylene glycol, ion-exchange water and the like was used as the dip plating solution. The copper foil piece cut into 10 cm square was dipped in the aqueous solution at 30° C. for 30 seconds and then was rinsed with water. Thus, a copper alloy layer containing copper and a trace of tin was formed on the surface of the copper foil piece as the adhesive metal layer.

The above copper foil piece thus surface treated was dipped in a 1 wt % aqueous solution of 3-glycidoxypropyltrimethoxysilane (30° C., 60 sec) and was subjected to brief drying (70° C., 30 sec) followed by water rinsing (ordinary temperature, 60 sec) and the final drying (70° C., 60 sec).

### EXAMPLES 2 TO 17

The electrodeposited copper foil pieces were treated in the same way as in Example 1, except that the drying temperature and/or the drying time was changed as shown in Table 1.

### COMPARATIVE EXAMPLE 1

The electrodeposited copper foil piece, which was surface treated in the same way as in the above Examples, was dipped in the 1 wt % aqueous solution of 3-glycidoxypropyltrimethoxysilane (30° C., 60 sec). The copper foil piece was immediately rinsed with water (ordinary temperature) Subsequently, the copper foil piece was dried (70° C., 60 sec).

### COMPARATIVE EXAMPLE 2

The electrodeposited copper foil piece, which was surface treated in the same way as in the above Examples, was dipped in the 1 wt % aqueous solution of 3-glycidoxypropyltrimethoxysilane (30° C., 60 sec) and was dried (70° C., 60 sec).

### COMPARATIVE EXAMPLE 3

The electrodeposited copper foil piece, which was surface treated in the same way as in the above Examples, was dipped in the 1 wt % aqueous solution of 3-glycidoxypropyltrimethoxysilane (30° C., 60 sec). The copper foil piece was subjected to brief drying (20° C., 30 sec) followed by water rinsing (ordinary temperature, 60 sec) and the final drying (70° C., 60 sec).

### COMPARATIVE EXAMPLE 4

The electrodeposited copper foil piece, which was surface treated in the same way as in the above Examples, was dipped in the 1 wt % aqueous solution of 3-glycidoxypropyltrimethoxysilane (30° C., 60 sec). The copper foil piece was subjected to brief drying (90° C., 6 min) followed by water rinsing (ordinary temperature, 60 sec) and the final drying (70° C., 60 sec)

### COMPARATIVE EXAMPLE 5

The electrodeposited copper foil piece, which was surface treated in the same way as in the above Examples, was dipped in the 1 wt % aqueous solution of 3-glycidoxypropyltrimethoxysilane (30° C., 60 sec). The copper foil piece was subjected to brief drying (170° C., 30 sec) followed by water rinsing (ordinary temperature, 60 sec) and the final drying (70° C., 60 sec)

### COMPARATIVE EXAMPLE 6

The electrodeposited copper foil piece, which was surface treated in the same way as in the above Examples, was dipped in the 1 wt % aqueous solution of 3-glycidoxypropyltrimethoxysilane (30° C., 60 sec). The copper foil piece was subjected to brief drying (70° C., 2 sec) followed by water rinsing (ordinary temperature, 60 sec) and the final drying (70° C., 60 sec).

The electrodeposited copper foil pieces treated in Examples 1 to 17 and Comparative Examples 1 to 6 were evaluated for the coating unevenness and the amount of surface silane as follows. The results are shown in Table 1.

### 1. Evaluation of Coating Unevenness

The electrodeposited copper foil pieces were evaluated for the coating unevenness by visually observing the surfaces thereof. A copper foil piece free from the coating unevenness was rated as very good, a copper foil piece partially suffering the coating unevenness was rated as good, and a copper foil piece suffering the coating unevenness on the entire surface was rated as NG.

### 2. Measurement on Amount of Surface Silane

The amount of surface silane was determined by XPS (X-ray photoemission spectroscopy). JPS-9010MC (X-ray photoelectron spectrometer commercially available from JEOL Ltd.) was used as a measurement instrument which was operated under measurement conditions including: Mg-ray source; an energy step of 0.1 eV; a pass energy of 50 eV; and a cumulative time of 200 ms. The amount of surface silane was determined based on Si 2p3/2 peak in the XPS spectra.

TABLE 1

| | Silane treatment | CI | SS(PI) |
|---|---|---|---|
| Ex. 1 | dip(30° C., 60 sec)→ dry(70° C., 30 sec)→ | Very | about |
| | rinse (OT, 60 sec)→ dry | good | 31,000 |
| Ex. 2 | dip(30° C., 60 sec)→dry(70° C., 60 sec)→ | Very | about |
| | rinse(OT, 60 sec)→ dry | good | 30,000 |
| Ex. 3 | dip(30° C., 60 sec)→dry(70° C., 150 sec)→ | Very | about |
| | rinse(OT, 60 sec)→ dry | good | 44,000 |
| Ex. 4 | dip(30° C., 60 sec)→ dry(80° C., 30 sec)→ | Very | about |
| | rinse(OT, 60 sec)→ dry | good | 37,000 |
| Ex. 5 | dip(30° C., 60 sec)→ dry(80° C., 60 sec)→ | Very | about |
| | rinse(OT, 60 sec)→ dry | good | 26,000 |
| Ex. 6 | dip(30° C., 60 sec)→ dry(80° C., 150 sec)→ | Very | about |
| | rinse(OT, 60 sec)→ dry | good | 31,000 |
| Ex. 7 | dip(30° C., 60 sec)→ dry(90° C., 30 sec)→ | Very | about |
| | rinse(OT, 60 sec)→ dry | good | 41,000 |
| Ex. 8 | dip(30° C., 60 sec)→ dry(90° C., 60 sec)→ | Very | about |
| | rinse(OT, 60 sec)→ dry | good | 35,000 |
| Ex. 9 | dip(30° C., 60 sec)→ dry(90° C., 150 sec)→ | Very | about |
| | rinse(OT, 60 sec)→ dry | good | 33,000 |
| Ex. 10 | dip(30° C., 60 sec)→dry(25° C., 30 sec)→ | Very | about |
| | rinse(OT, 60 sec)→ dry | good | 20,000 |
| Ex. 11 | dip(30° C., 60 sec)→ dry(60° C., 30 sec)→ | Very | about |
| | rinse(OT, 60 sec)→ dry | good | 23,000 |
| Ex. 12 | dip(30° C., 60 sec)→dry(65° C., 30 sec)→ | Very | about |
| | rinse(OT, 60 sec)→ dry | good | 24,000 |
| Ex. 13 | dip(30° C., 60 sec)→ dry(90° C., 10 sec)→ | Very | about |
| | rinse(OT, 60 sec)→ dry | good | 24,000 |
| Ex. 14 | dip(30° C., 60 sec)→ dry(90° C., 5 min)→ | good | about |
| | rinse (OT, 60 sec)→ dry | | 37,000 |
| Ex. 15 | dip(30° C., 60 sec)→ dry(120° C., 150 sec)→ | Very | about |
| | rinse(OT, 60 sec)→ dry | good | 36,000 |
| Ex. 16 | dip(30° C., 60 sec)→ dry(120° C., 30 sec)→ | Very | about |
| | rinse(OT, 60 sec)→ dry | good | 41,000 |
| Ex. 17 | dip(30° C., 60 sec)→ dry(150° C., 30 sec)→ | good | about |
| | rinse(OT, 60 sec)→ dry | | 36,000 |
| CEx. 1 | dip(30° C., 60 sec)→ rinse(OT, 60 sec)→ dry | Very | about |
| | | good | 10,000 |
| CEx. 2 | dip(30° C., 60 sec)→ dry | NG | about |
| | | | 55,000 |
| CEx. 3 | dip(30° C., 60 sec)→ dry(20° C., 30 sec)→ | Very | about |
| | rinse(OT, 60 sec)→ dry | good | 17,000 |
| CEx. 4 | dip(30° C., 60 sec)→ dry(90° C., 6 min)→ | NG | about |
| | rinse(OT, 60 sec)→ dry | | 38,000 |
| CEx. 5 | dip(30° C., 60 sec)→ dry(170° C., 30 sec)→ | NG | about |
| | rinse(OT, 60 sec)→ dry | | 37,000 |
| CEx. 6 | dip(30° C., 60 sec)→ dry(70° C., 2 sec)→ | Very | about |
| | rinse(OT, 60 sec)→ dry | good | 12,000 |

Note:
OT denotes the ordinary temperature (25° C.);
CI denotes the coating unevenness;
SS denotes the amount of surface silane; and
PI denotes the peak intensity.

The electrodeposited copper foil pieces treated in Examples 1 to 17 and Comparative Examples 1 to 6 were visually observed. No coating unevenness or only local coating unevenness were observed on those of Examples 1 to 9. On those of Comparative Examples 2, 4 and 5, the uneven deposition of the silane coupling agent as shown in FIG. 2(c) was obvious.

As to the amount of surface silane, those of Examples 1 to 9 and Comparative Example 2 were sufficiently formed with the films of silane coupling agent. However, those of Comparative Examples 1, 3 and 6 were low in the amount of surface silane. The acceptance criterion for the amount of surface silane is a peak intensity of 20,000 or more. The peak intensities of those of Comparative Examples 1 and 3 did not reach the acceptance level.

1. A method for forming a film of silane coupling agent on a metal surface comprising:
a step of applying a solution containing a silane coupling agent on the metal surface;
a step of drying the metal surface coated with the solution at a temperature in the range of 25 to 150° C. and for a length of time of 5 minutes or less; and
a step of water-rinsing the dried metal surface.

2. A method for forming a film of silane coupling agent according to claim 1, wherein the metal surface is previously subjected to surface treatment for forming an adhesive metal layer thereon by using a dip plating solution.

3. A method for forming a film of silane coupling agent according to claim 1, wherein the silane coupling agent is at least one selected from the group consisting of 3-glycidoxypropyltrimethoxysilane, 3-glycidoxypropyltriethoxysilane, 2-(3,4-epoxycyclohexyl)ethyltrimethoxysilane, and 3-glycidoxypropylmethyldiethoxysilane.

4. A method for forming a film of silane coupling agent according to claim 1, wherein the drying time is in the range of 30 seconds to 150 seconds.

5. A method for forming a film of silane coupling agent according to claim 2, wherein the silane coupling agent is at least one selected from the group consisting of 3-glycidoxypropyltrimethoxysilane, 3-glycidoxypropyltriethoxysilane, 2-(3,4-epoxycyclohexyl)ethyltrimethoxysilane, and 3-glycidoxypropylmethyldiethoxysilane.
